(19) United States
(12) Patent Application Publication
(10) Pub. No.: US 2026/0102836 A1
(43) Pub. Date: Apr. 16, 2026

(54) METHOD AND APPARATUS FOR MINIMIZING GAS USAGE IN GAS SHIELDED INDUSTRIAL PROCESSES

(71) Applicants: Thomas R. Kruer, Edgewood, KY (US); Larry Cherne, Brookfield, WI (US); Robert P. Schaefer, Vineyard Haven, MA (US)

(72) Inventors: Thomas R. Kruer, Edgewood, KY (US); Larry Cherne, Brookfield, WI (US); Robert P. Schaefer, Vineyard Haven, MA (US)

(21) Appl. No.: 18/913,148

(22) Filed: Oct. 11, 2024

(51) Int. Cl. B23K 9/32

(52) U.S. Cl. CPC B23K 9/325

(57) ABSTRACT

A method and apparatus reduces the consumption of process gases used in gas shielded industrial processes such as gas metal arc welding (GMAW), metal inert gas (MIG) welding, tungsten inert gas (TIG) welding, laser welding, plasma welding and plasma arc cutting processes by containing and capturing process gases used at a work site. The captured gases are drawn into a recirculating circuit, filtered to remove impurities, molecularly separated, and injected back into the incoming gas supply line. A hood substantially contains the process gases at the work site and a recirculating pump draws the process gases from the filter and molecular sieve where they are injected into the gas supply line.

### FIELD OF THE INVENTION

This invention relates to equipment and methods used in various forms of gas shielded industrial processes, including gas metal arc welding (GMAW), metal inert gas (MIG) welding, tungsten inert gas (TIG) welding, laser welding, plasma welding and plasma arc cutting processes, specifically relating to arc welding and cutting processes that make use of a gas mixture. This invention particularly relates to novel devices and methods that minimize the gas consumed by delivering and recycling the expensive components of the gas mixture used during these processes.

### BACKGROUND OF THE INVENTION

Gas metal arc welding (GMAW), metal inert gas (MIG) welding, tungsten inert gas (TIG) welding, laser welding, plasma welding and plasma arc cutting processes are used in the fabrication of metallic parts and are well-known in the prior art. GMAW processes, for example, utilize a gas mixture typically comprising an arc gas and an inert gas. The arc gas creates a localized region around the feedwire (consumable electrode through which electrical power is applied to melt it in an arc), allowing for the creation and maintaining of the arc with less power. An inert gas is used to shield the molten pool of metal from contaminants within the surrounding atmosphere. Inert gases used in this process include, without limitation, argon and other inert gases that are nonreactive during the GMAW, MIG welding, TIG welding, laser welding, plasma welding and plasma arc cutting processes. A disadvantage of these processes is that such inert gases, including without limitation, Argon, are difficult and costly to produce which contributes to the cost of the part being fabricated.

One specific example of the use of gas usage in a gas shielded industrial process is presented in a typical GMAW application, wherein the weld gas mixture is supplied at the weld site at a rate of 20 liters per hour or more, with the rate varying depending upon the kind of metal being welded, the environment, and the physical size of the weld. If the process is an additive manufacturing application, the size of the part being fabricated is a factor in gas consumption. While the GMAW process is particularly illustrated herein, the use of gas mixtures in MIG welding, TIG welding, laser welding, plasma welding and plasma arc cutting processes are also applicable and contemplated.

The GMAW process is typically done in an open environment where fumes and the gases are free to dissipate into the surrounding atmosphere or extracted to protect the health of the human operator and vented elsewhere. While the release of gas and fumes into the open air environment provides effective dissipation, it is costly insofar as the expensive inert gas being supplied to shield the molten metal from contaminants is one of the components so released into the environment.

The gases used in these processes, including the illustrative GMAW process discussed utilizing inert gas, are typically provided in high-pressure cylinders, which must be stockpiled and regularly replaced when empty.

There is a need and desire to modify these processes, including without the limitation the GMAW process, to minimize the amount of process gases consumed, thus reducing the cost and the time and inconvenience associated with the frequent changing out of high-pressure gas cylinders.

Prior art United States Patent U.S. Pat. No. 7,544,914 B2 and German patent DE102021111790A teach a welding torch with an annular member surrounding the axial end of the nozzle, with a plurality of openings oriented such that fumes, excess gases, and ambient air are extracted from the area of the weld. The fumes, gases, and air are collected and extracted and purged from the area.

GMAW processes are also used in some metal additive manufacturing systems to create three-dimensional parts using wire as the feedstock. As in other welding applications, wire arc additive manufacturing (WAAM) utilizes a gas mixture to maintain the arc and shield the molten pool of metal from contamination. Also, as in other applications, the cost of WAAM produced parts includes the cost of the gas consumed as well as the downtime associated with the replacement of the gas cylinders.

One prior art approach to minimizing inert gas usage teaches the use of an airtight enclosure in which the welding process is performed. The air in the enclosure is evacuated and the process is done in a vacuum. Such airtight enclosures are bulky, expensive, and the process must be done through glove holes or by remote control. Alternatively, the welding process can be performed in an airtight enclosure filled with inert gas instead of welding in a vacuum. While this reduces the amount of inert gas required as compared to an open air process, evacuating the enclosure and filling it with inert gas is very time consuming. The period of time that the enclosure is being filled is non-productive time for the machine and adds to the final cost of the product being fabricated. United States Patent Application Publication US 2022/0266371 A1 teaches the principle of reducing or discontinuing gas flow when the enclosure is partially full because it is not necessary that the inert gas fills the entire enclosure, but rather only shields the fabrication location.

Therefore, there is identified a long felt need to minimize the inert gas utilized during GMAW processes without impacting the operating time and availability of the machine.

### SUMMARY OF THE INVENTION

The present invention introduces an apparatus and method used in combination with gas shielded industrial processes utilizing arc cutting and welding torches to reduce the amount of inert gas consumed during welding and cutting processes. The apparatus specifically reduces the gas consumed in gas metal arc welding, TIG welding, MIG welding, laser welding or plasma cutting processes and comprises the basic components of a gas supply line providing at least one process gas to a torch, means for capturing a process gas at a work site, and means for injecting the process gas captured by the capturing means back into the incoming gas supply line. In the most preferred embodiment of the present invention, the process gas contains a large portion of inert shielding gas. The process gas is recycled through a recirculating circuit between the capturing means at the work site and an inlet port in the incoming gas supply line.

The preferred embodiment also provides a means for inducing a flow of the captured gas from the capturing means at the work site to the inlet in the incoming gas line, the inducing means being a recirculating pump in the most preferred embodiment of the present invention.

The means for capturing in the preferred embodiment comprises a hood that substantially contains the process gases at the work site. The hood is in fluid communication with the recirculating circuit through an exit port formed in the hood.

Within the recirculation circuit there is gas purification equipment inline. In the most preferred embodiment of the present invention the process gas is treated through a filter to remove impurities and through a molecular sieve to separate gaseous components as it is being recycled from the work site to the inlet on the incoming gas supply line.

The preferred embodiment of the present invention also provides a method for recapturing and recycling process gases used in gas metal arc welding and plasma cutting processes. The first step in the preferred embodiment is containing and capturing process gas at the work site. Next, the flow of the captured gas is induced into a recirculating circuit where the captured process gas is filtered and separated with a molecular sieve. Finally, the captured, filtered and separated process gas is interjected into the stream of supply gas, such that a decreased amount of new gas from the supply is required for the process.

The disclosed apparatus and the method provides for the inert gas to be delivered to the work site, collected at and extracted from the work site, filtered and cleaned, and then recycled back into the process thus minimizing the inert gas required. The present invention also provides the structural components and methods to effectively accomplish the delivery, collection, extraction, cleaning, and recycling operations.

### BRIEF DESCRIPTION OF THE DRAWINGS

FIG. 1 depicts a typical torch used in a GMAW process.

FIG. 2 is a schematic block diagram depicting the major components of prior art GMAW processes.

FIG. 3 depicts a generalized schematic representation of the major components of a GMAW process performed within an airtight enclosure.

FIG. 4 is a generalized schematic representation of the major components of a GMAW process applied to an additive manufacturing system that reduces the amount of gas used by partially filling the enclosure.

FIG. 5 is a schematic representation of a GMAW process applied to a typical seam weld.

FIG. 6A is a generalized schematic representation and illustrative model of the major components of the present invention, and FIGS. 6B and 6C are perspective depictions of the details of the illustrative model.

FIG. 7 is an isometric depiction of the major components of the gas recycling assembly of the present invention fitted to a typical GMAW torch.

FIG. 8 is a cross-section view of the recycling assembly of the present invention fitted to a typical GMAW torch.

FIG. 9 depicts the major components of the gas recycling assembly of the present invention.

### DETAILED DESCRIPTION OF THE PREFERRED EMBODIMENT

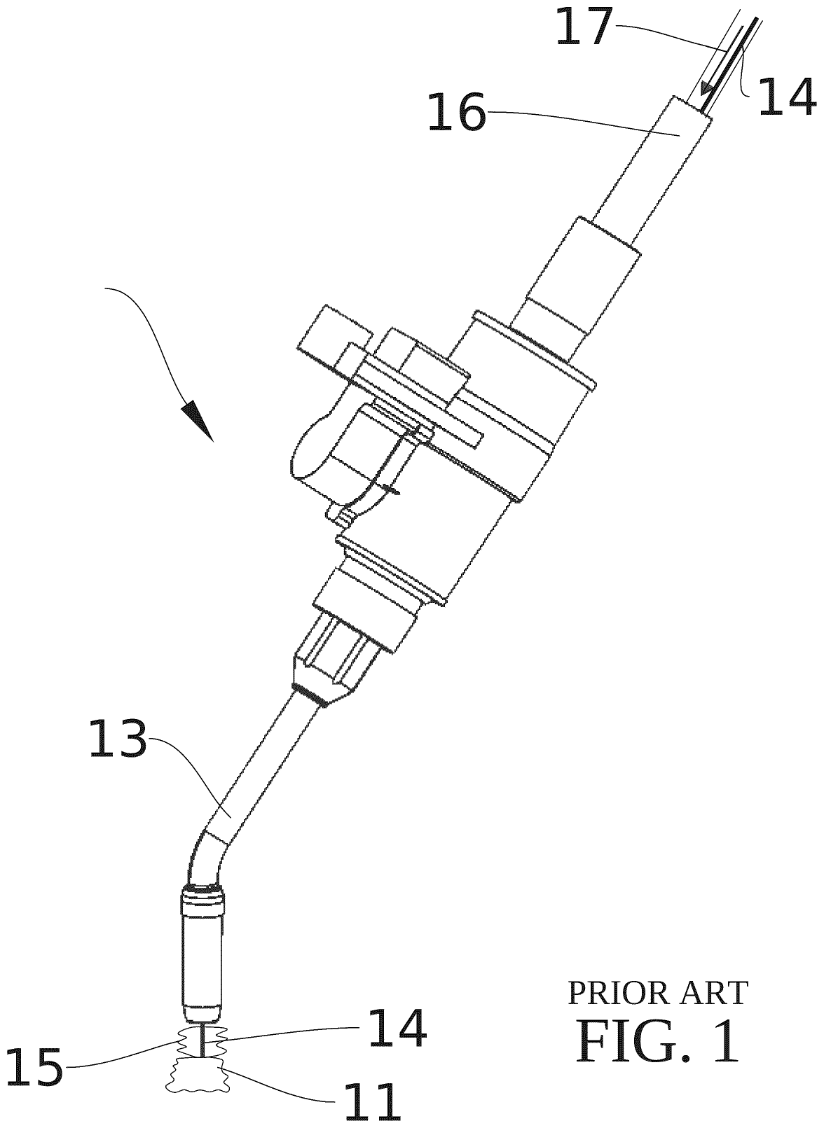

FIG. 1 illustrates a typical torch 12 used in a gas shielded arc welding process. Feedwire 14 is fed to the torch 12 through a hose 16 and an electrical current is provided to the feedwire 14 to create a welding arc. The hose 16 and conductor tube 13 also convey a stream of process gas mixture 17 to the weld site 11. The depicted process is an example in the class of a gas-shielded industrial processes which also comprises metal inert gas (MIG) welding, tungsten inert gas (TIG) welding, laser welding, plasma welding and plasma arc cutting processes. For purposes of this disclosure the principles enabling the minimization of gas usage are applicable to all such gas shielded industrial processes.

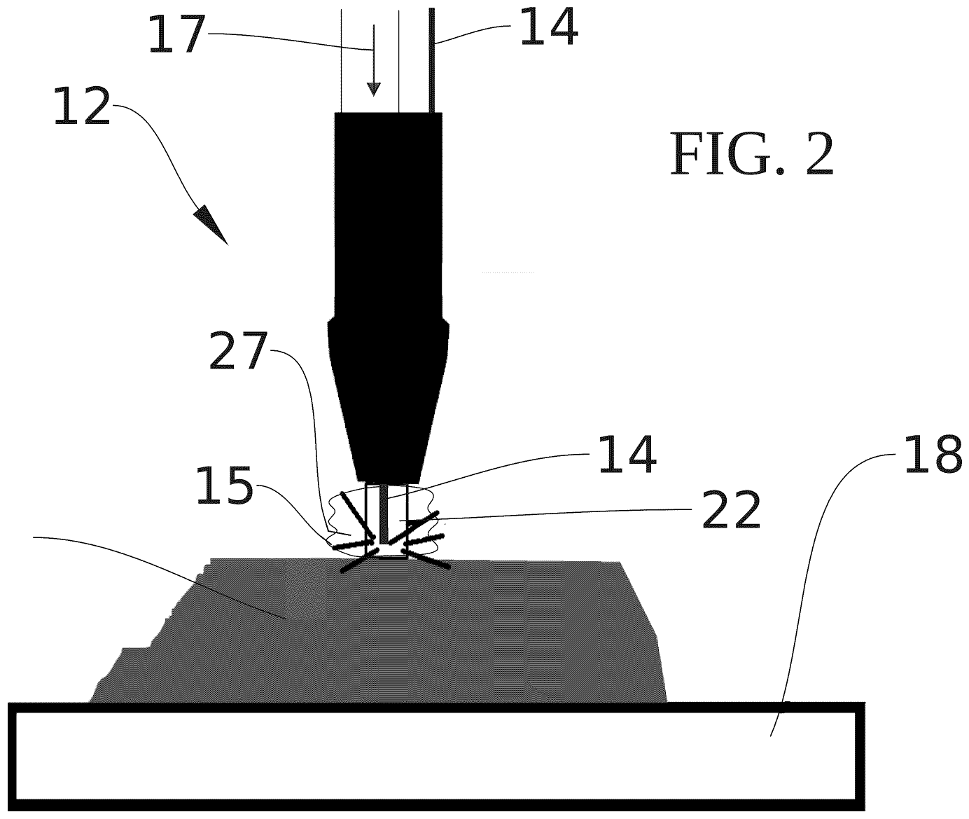

As depicted in FIG. 2, a Gas Metal Arc Welding (GMAW) process is used in a Wire Arc Additive Manufacturing (WAAM) application. As discussed in more detail, the principles, apparatus and methods of recycling the process gases are of utility in GMAW processes in general, and application is not limited to WAAM applications. The torch 12 is positioned over a weld site on a build table 18 on which a part 20 is fabricated. The build table 18 acts as both a support surface for the part 20 and it completes the electric circuit required for establishing an arc for the GMAW welding process. The gas mixture 17 typically contains an arc gas and an inert gas supplied from a remotely located supply tank. The arc gas creates a localized region 22 around the feedwire 14, allowing for the creation and maintaining of the arc between the feedwire 14 and build table 18 with less power. The inert gas portion 15 of the gas mixture 17 creates a localized shield 27 around the area to protect the molten material in the part 20.

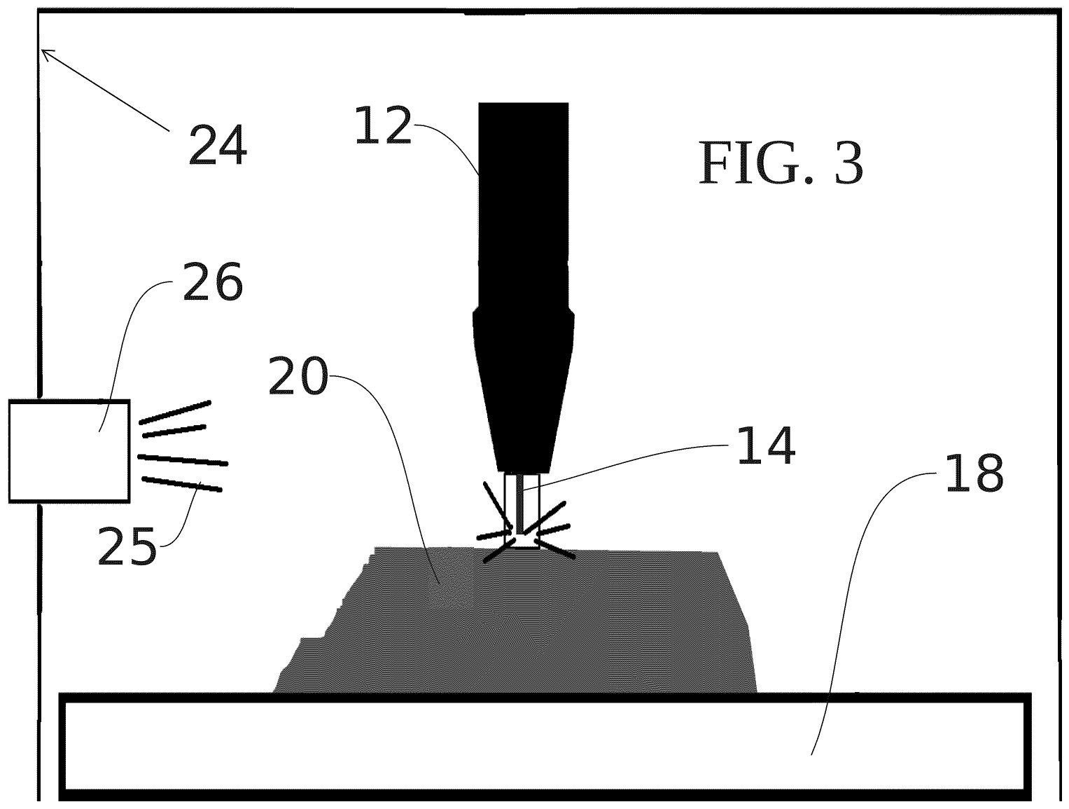

FIG. 3 shows a prior art GMAW welding process performed while contained within an enclosure 24. The enclosure 24 houses the build table 18 and the gas metal arc welding torch 12 that fabricates part 20 using a GMAW process. The enclosure 24 is beneficial in that, in this embodiment, the inert gas 25 provided through an inlet 26 prior to initiation of the welding process is contained to reduce consumption and the need to replenish the inert gas supply, and not vented to the surrounding environment during the welding process. Alternatively instead of providing process gases at inlet 26 until the enclosure 24 is full, all gases, including ambient air, are removed from the enclosure. Both methods effectively promote a stabilized, controlled environment for the welding process. However, a disadvantage of providing a vacuum enclosure 24 to prevent contamination is that the enclosure 24 must be of airtight and robust construction to withstand evacuation, adding to the cost of the enclosure 24.

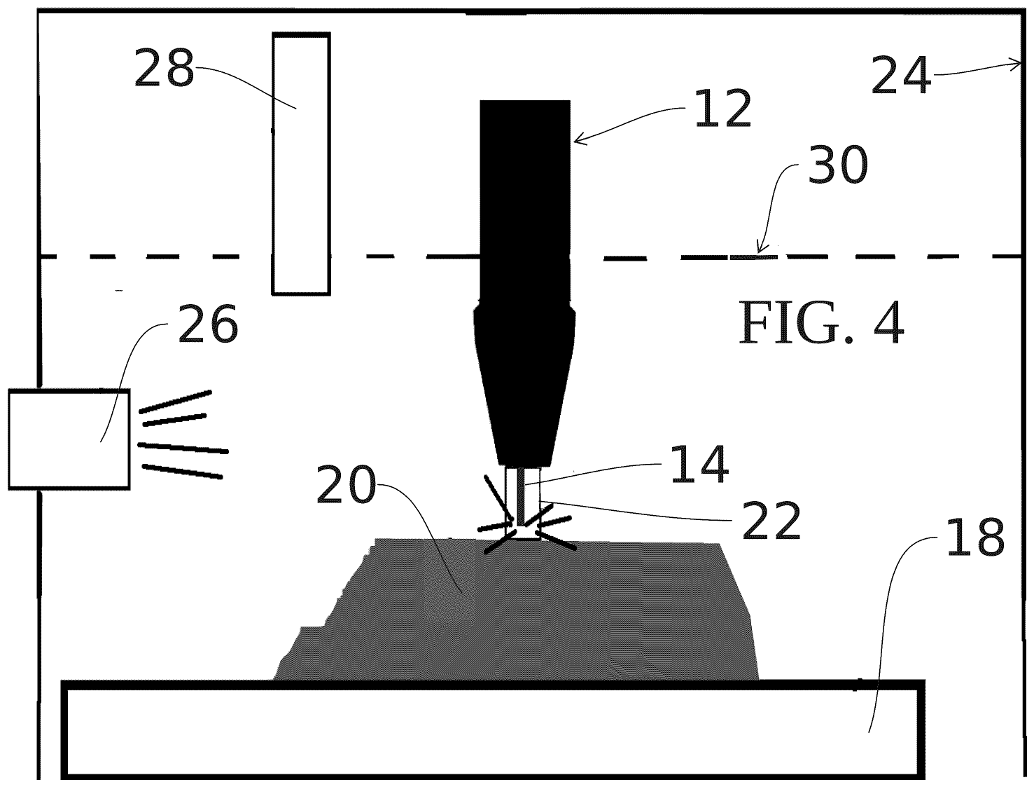

FIG. 4 shows the GMAW process enclosure wherein a sensor 28 is provided to detect when inert gas level 30 has been achieved to allow the inert gas flow to be reduced or discontinued when the enclosure 24 is partially full. It is not necessary to completely fill the enclosure 24 in this embodiment. Inert gas is introduced until the volumetric level of the gas exceeds that of level 30, tripping sensor 28 to assure that the part 20 or the weld pool 19 are effectively submerged in the inert gas. As with the previously discussed prior art, a stream of arc gas may also be provided through the torch 12 to replace any leakage and provide a localized region 22 of inert gas 15 around the feedwire 14, allowing for the creation and maintaining of the welding arc with less power.

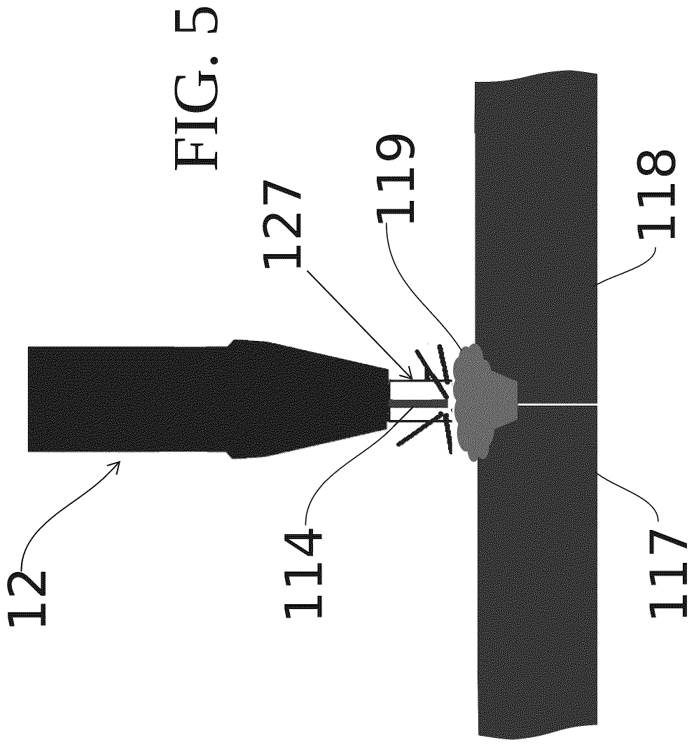

Another example of a gas shielded process is depicted in FIG. 5 wherein a typical torch 12 is used in gas shielded arc welding process depositing a weld bead 119 between two plates 117, 118. As shown in FIG. 5, the seam weld pool 119 is produced from feedwire 114 having a localized gas shield 127. The provision of a localized gas shield 127 is typical across applications of gas-shielded industrial processes including without limitation metal inert gas (MIG) welding, tungsten inert gas (TIG) welding, laser welding, plasma welding and plasma arc cutting processes, in addition to the GMAW process depicted herein.

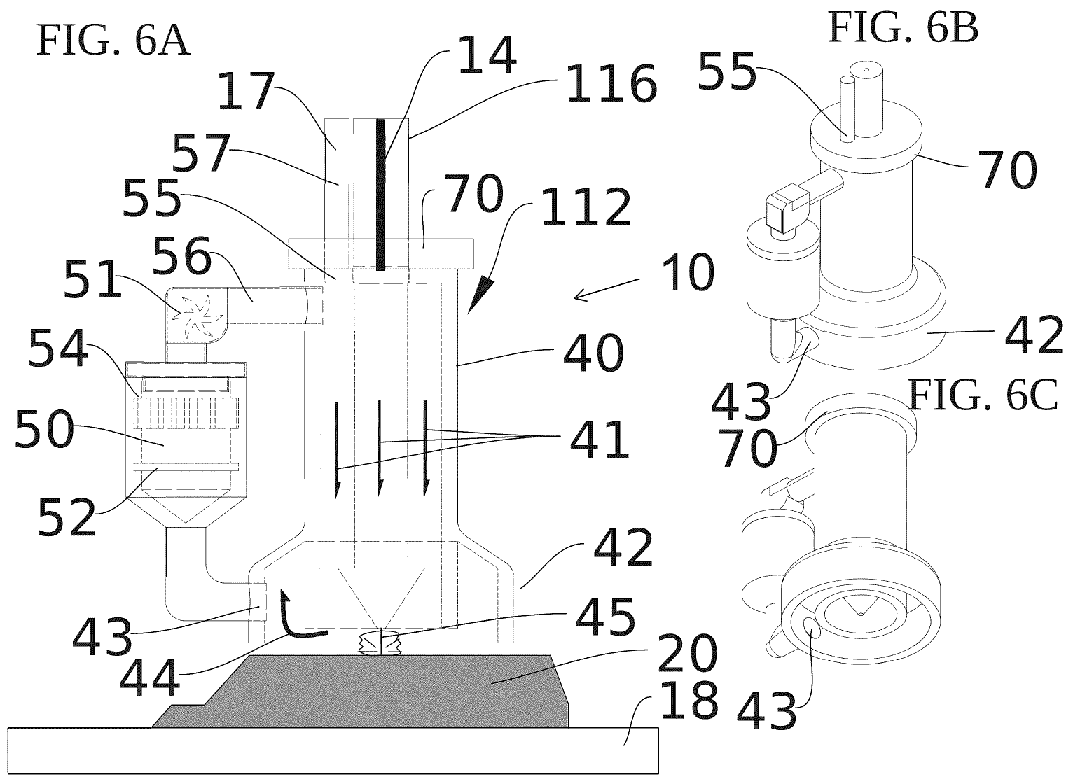

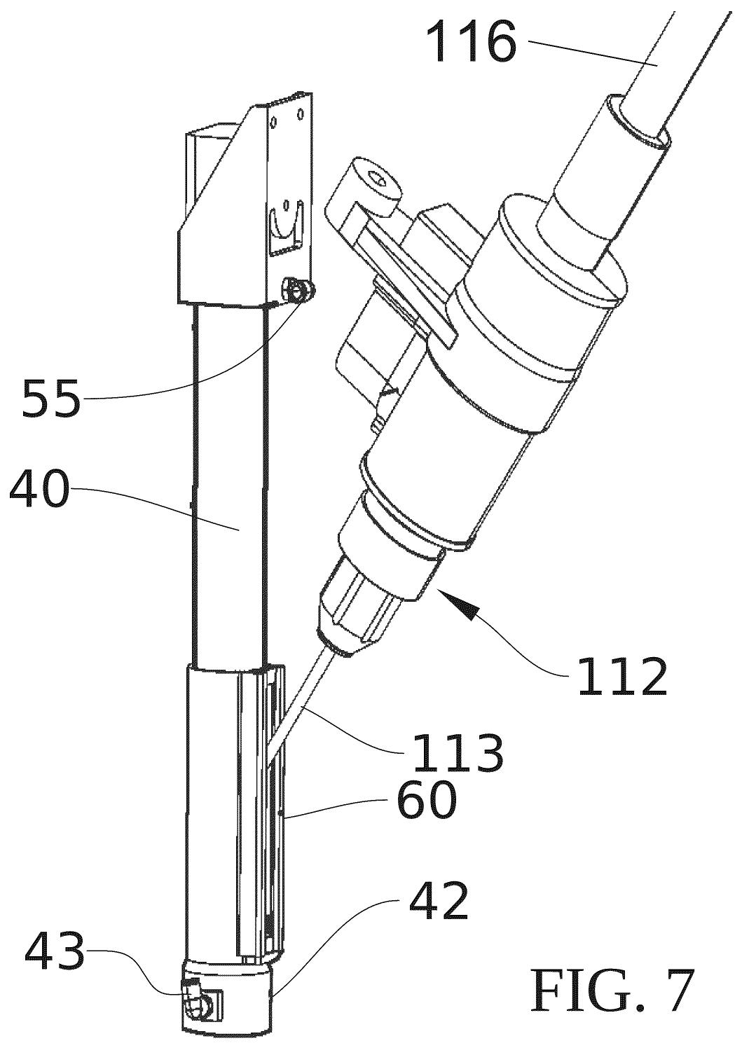

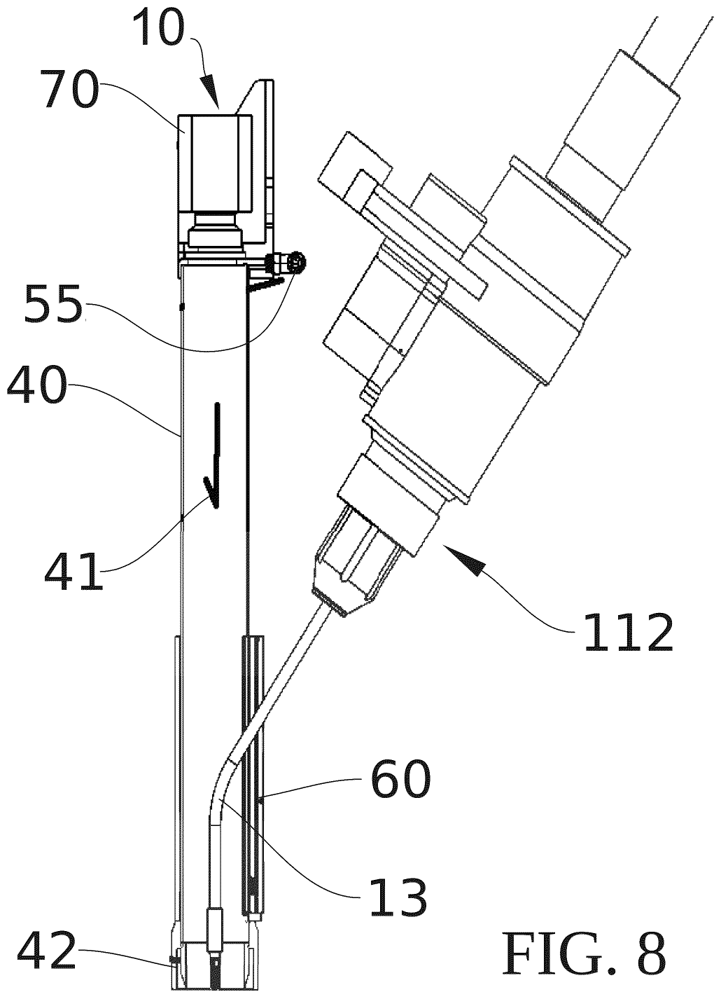

The gas recycling assembly 10 of the present invention is depicted schematically as an illustrative model in FIGS. 6A, 6B and 6C, and as constructed in FIGS. 7 and 8. The depicted torch 112 of the present invention is a modified version of those used in gas metal arc welding processes (GMAW). As in a typical GMAW torch, feedwire 14 is fed through the torch 112 by way of a small diameter contactor tube 113 and an electrical current is provided to the feedwire 14 to create a welding arc between the feedwire 14 and a conductive build table 18. The torch 112 of the present invention is connected to a small diameter hose 116 through which feedwire 14 along with a small stream of arc gas are fed to the work site through torch 112. The arc gas provides an optimal environment for the arc.

FIG. 6A illustrates the present invention of the gas recycling assembly 10 partially enclosing the conductor tube 113 of the arc welding torch 112. The gas recycling assembly of the present invention consists of a sleeve 40, having a gas supply port 55 at one end, and a gas outlet 43 at the opposite end. During the welding process, inert gas is provided through the hose 116 and gas supply port 55 into the sleeve 40 at a very low rate. The inert gas, typically a heavy, dense gas like argon, fills the sleeve 40 and moves down the sleeve 40 in streams 41 to surround the weld pool at the part 20 being fabricated. A concentric extractor 42 is fitted to the sleeve 40. The extractor 42 includes a gas outlet 43. The atmosphere in the direct vicinity to the weld pool at the part 20 is constantly being vacated in a stream 44 into the concentric extractor 42 and then drawn out into the gas outlet 43. This extraction ensures a constant flow of inert gas through stream 41.

In the most preferred embodiment of the present invention an arc gas 45 is supplied through the torch 112 at a very low rate to maintain the welding arc at the tip of the torch 112. The arc gas 45 can be a different composition than the surrounding inert shield gas 15. Typical arc gas mixture includes carbon dioxide and helium, although other gases are contemplated by the principles of this invention, such that substitution or replacement with such other gases does not depart from the principles of the present invention. The arc gas 45 can be changed with different compositions without needing to change the inert gas or other components of the process.

The collected inert gas and fumes extracted through the gas outlet 43 are passed into a gas processing unit 50. The gas processing unit 50 typically contains an in-line vacuum pump 51, an air filter 52, and a molecular sieve 54. The vacuum pump 51 pulls the atmosphere through the gas outlet 43. An air filter 52 removes any suspended particles, such as dirt and smoke, from the recycle stream 44. A molecular sieve 54 separates the inert gas from any other constituent gases in the recycle stream 44. Once filtered and sieved, the inert gas is re-introduced into the sleeve 40 near the gas inlet 57 by way of a return tube 56. The combination of the concentric extractor 42, gas outlet 43, gas processing unit 50 and return tube 56 represent a recirculating path for the inert gas.

FIG. 6A further presents an optional sensor 70 positioned near the top of the sleeve 40 looking downward through the tube 40 to monitor the welding process via either a direct visual feed or thermal based optics. The optional sensor 70 can be used to measure the gas composition in the sleeve 40, the temperature of the part 20, and other parameters, as needed. As depicted in FIG. 6A, it is a significant aspect of the present invention that the inert gas flow 41 moves downward in sleeve 40, thus removing and eliminating any suspended particles, such as dirt and smoke that could interfere with the operation of the optional sensor 70.

FIGS. 6B and 6C displays for better visualization a modeled prototype of the inert gas inlet port 55, concentric extractor 42 and the gas outlet 43 of the gas recycling assembly 10 fitted to a welding torch 112.

FIG. 7 illustrates how the functional sleeve 40 of the present invention is fitted to a typical arc welding torch 112 by using a strip brush 60. The strip brush 60 creates an effective seal around the irregular shape of the torch 112 conductive tube 113. The brush 60 provides a substantially airtight design around the tube 113 while also providing a means for adapting the gas recycling assembly 10 for various welding heads of varying sizes and shapes.

FIG. 8 illustrates the gas recycling assembly 10 of the present invention in a sectioned view fitted to a modified arc welding torch 112. Inert gas stream 41 generated by the flow through return tube 55 shows the direction of airflow with respect to the sleeve 40. The relative size and shape of the concentric extractor 42 for vacating air in one embodiment is also illustrated.

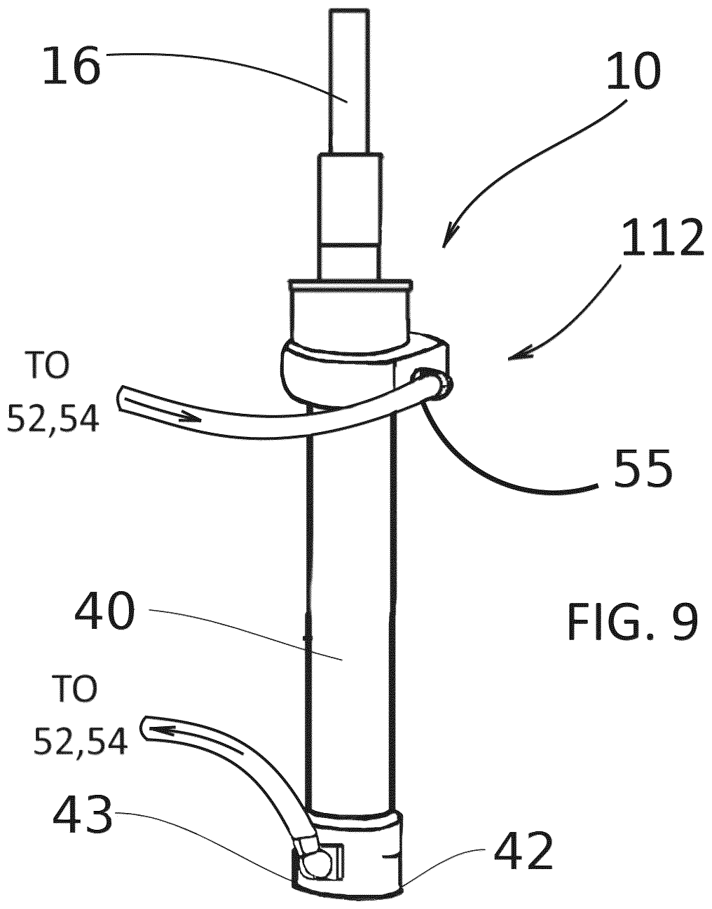

FIG. 9 illustrates the gas recycling assembly 10 of the present invention fitted to a custom arc welding torch 112 with a linear form in an isometric view. The placement of the gas ports are shown in greater detail. The gas return port 55 and outlet port 43 of this embodiment receive typical flexible tubing that will run to a filter 52 and sieve 54 in a large recyclable loop, ensuring the concentration and quality of the inert gas.

I claim:

1. An apparatus reducing the gas consumed in gas shielded industrial processes comprising:
a process gas supply line, providing at least one process gas to a torch;
means for capturing said process gas at a work site; and
means for conveying captured process gas by said means for capturing back into said gas supply line.

2. The apparatus as set forth in claim 1 wherein said at least one process gas comprises a shielding gas.

3. The apparatus and set forth in claim 2 wearing said shielding gas comprises an inert gas.

4. The apparatus as set forth in claim 1 wherein said means for conveying comprises a recirculating circuit between said means for capturing and a recycle inlet port in said process gas supply line.

5. The apparatus as set forth in claim 4 further comprising a means for inducing said captured process gas to flow from said means for capturing to said recycle inlet.

6. The apparatus as set forth in claim 5 wherein said means for inducing comprises a recirculating pump.

7. The apparatus as set forth in claim 6 wherein said means for capturing comprises a hood substantially containing process gases provided at the weld site, further comprising an exit port conveying said process gases to said recirculating circuit.

8. The apparatus as set forth in claim 7 further comprising a gas purification device inline in said recirculating circuit.

9. The apparatus as set forth in claim 8 wherein said gas purification device comprises a filter to remove impurities in said captured process gas.

10. The apparatus as set forth in claim 9 wherein said gas purification device further comprises a molecular level gas separation device.

11. The apparatus as set forth in claim 10 wherein said molecular level gas separation device comprises a molecular sieve.

12. A method for capturing and recycling process gases used in gas metal arc welding and cutting processes, surprising the steps of:
substantially containing and capturing at least one process gas provided at a work site;
inducing flow of the captured process gas contained into a recirculating circuit; and
injecting the captured process gas back into the gas supply line.

13. The method as set forth in claim 12 wherein said inducing flow step comprises providing a negative pressure in the recirculating circuit that draws the captured process gas into the recirculating circuit.

14. The method as set forth a claim 12 further comprising, a step of filtering the captured process gas to remove impurities prior to recycling the captured process gas back into the gas supply line.

15. The method as set forth in claim 12 further comprising a step of separating gases at a molecular level prior to recycling the captured process gas back into the gas supply line.
